(19) United States
(12) Patent Application Publication
(10) Pub. No.: US 2005/0241526 A1
(43) Pub. Date: Nov. 3, 2005

(54) Mixtures of finely ground waxes

(76) Inventors: Franz-Leo Heinrichs, Gablingen (DE); Ernst Krendlinger, Friedberg (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/516,928

(22) PCT Filed: May 30, 2003
(86) PCT No.: PCT/EP03/05669

§ 371 Date: Dec. 3, 2004

(30) Foreign Application Priority Data
Jun. 5, 2002 (DE) 102 24 845.1

(51) Int. Cl. C09D 11/12

(52) U.S. Cl. 106/31.29; 106/31.3; 106/31.31; 106/31.61; 106/31.62; 106/31.63

(57) ABSTRACT

Mixtures of finely ground waxes, including two or more components A, B, C, and/or D, wherein ester waxes are used as component A, amide waxes are used as component B, hydrocarbon waxes are used as component C, and oxidized long-chain hydrocarbon waxes are used as component D. The mixtures of the present invention are useful as additives in printing inks, coatings, plastics and crop-protection formulations; as a lubricant in plastics, and as a pigment dispersant.

The invention relates to mixtures of finely ground waxes, comprising two or more components A, B, C, and/or D, and to their use.

The use of waxes as processing aids for plastics, for the dispersing of pigments in plastics, as additive in printing inks and in coatings, as a processing aid for powder coatings, and in a number of other applications, is known. Many of these applications need waxes in ground form, permitting lower energy usage in processing, and therefore more cost-effective processing, and better dispersion, and smaller amounts added. Products of this type based on hydrocarbon waxes or on amide waxes are known. These are easy to grind and, for various applications, are also combined with other products, e.g. PTFE powders.

The compatibility of these non-polar waxes with non-polar media, such as aliphatic or aromatic solvents, polyethylene, polypropylene, and other non-polar substances, is very good. However, there is an increasing need for finely ground waxes for polar systems, too, because in this case non-polar waxes cannot always be used, because the result is often incompatibility.

Alternatives here are oxidized hydrocarbon waxes or polar natural waxes and their derivatives, such as montane wax acid derivatives.

Products of this type are known, examples being®Ceridust 121 or ®Ceridust E/OP from Clariant GmbH, but their application is subject to restrictions, because grinding yield is low and this is associated with poor cost-effectiveness. As an alternative, wax powders can be produced by spray drying, but here there are restrictions in terms of heat resistance and viscosity, and also in the combination of various waxes or wax powders.

An object was therefore to find a technically simple method of providing finely ground polar waxes, so that the performance advantages of fine waxes can also be utilized in applications in polar media.

This object is achieved via mixtures of finely ground waxes, comprising two or more components A, B, C, and/or D, wherein ester waxes are used as component A, amide waxes are used as component B, hydrocarbon waxes are used as component C, and oxidized long-chain hydrocarbon waxes are used as component D.

The ester waxes are preferably natural ester waxes are synthetic ester waxes.

The natural ester waxes are preferably montane waxes, carnauba wax, candelilla wax, and/or sugarcane wax.

It is preferable that the montane waxes are montane wax acid, derivatives of montane wax acid, e.g. esters of montane wax acid, soaps of montane wax acid, esteramides of montane wax acid, and/or a mixture of derivatives of montane wax acid with long-chain fatty acids.

The synthetic ester waxes are preferably sorbitan esters of unsaturated fatty acids, esters of polyols, such as pentaerythritol, glycerol, trimethylolpropane, with long-chain fatty acids, and/or their mixtures.

Other preferred synthetic ester waxes are copolymers composed of long-chain olefins having from 5 to 18 carbon atoms and of unsaturated acids, such as acrylic acid, methacrylic acid, maleic anhydride, itaconic acid, and/or derivatives of these acids.

The derivatives are preferably methyl, ethyl, butyl, and/or 2-ethyhexyl esters of acrylic acid, methacrylic acid, maleic anhydride, and/or itaconic acid.

The copolymers are preferably those whose carboxy functionality has been modified via reaction with long-chain alcohols, with perfluoroalkyl alcohols, with short-chain amines, and/or with long-chain amines.

The long-chain alcohols are preferably tallow fatty alcohol, coconut fatty alcohol, and/or oxo alcohols.

The perfluoroalkyl alcohols are preferably C₈-C₁₈-perfluoroalkylpropanol, and/or narrower cuts of these alcohols.

Examples of the classes of these perfluoroalkylpropanols are C₈-C₁₂-, C₁₄-C₁₈-, C₈-C₁₄-, and other perfluoroalkylpropanols with a different number and distribution of carbon atoms.

The short-chain amines are preferably butylamine, dimethylaminopropylamine, diethylaminoethanol, tetramethylpiperidinol, and/or diacetonediamine.

The long-chain amines are preferably tallow fatty amine, octylamine, palmitylamine, and/or stearylamine.

The amide waxes are preferably reaction products composed of an amine component and of long-chain fatty acids or hydroxy fatty acids, and/or their mixtures.

The amine components are preferably ethylenediamine and/or hexamethylenediamine.

The amide waxes are preferably reaction products composed of ammonia and of long-chain fatty acids or hydroxy fatty acids, and/or their mixtures.

The amide waxes are preferably reaction products composed of long-chain amines, such as hydrogenated tallow fatty amine, stearylamine, palmitylamine, coconut fatty amine, and of long-chain fatty acids or hydroxy fatty acids, and/or their mixtures.

The hydrocarbon waxes are preferably polyethylene waxes.

Preference is given to those polyethylene waxes which have been prepared by the Ziegler process or by means of metallocene technology.

As an alternative, the polyethylene waxes are Fischer-Tropsch waxes.

The inventive mixture preferably comprises the following finely ground waxes:
from 40 to 99% by weight of component A
from 0 to 95% by weight of component B
from 0 to 95% by weight of component C
from 0 to 95% by weight of component D,
where the entirety of the components is 100% by weight.

The inventive mixture particularly preferably comprises the following finely ground waxes:
from 40 to 90% by weight of component A
from 0 to 60% by weight of component B
from 0 to 60% by weight of component C
from 0 to 60% by weight of component D,
where the entirety of the components is 100% by weight.

The invention also provides the use of the inventive mixtures of finely ground waxes as additive in printing inks, or in powder coatings or other coatings.

The invention also provides the use of inventive mixtures of finely ground waxes for the dispersion of pigments and of additives in plastics.

The invention also provides the use of inventive mixtures of finely ground waxes as hydrophobicizing additive in crop-protection preparations.

Finally, the invention also provides the use of mixtures of finely ground waxes as lubricant in various plastics.

Approaches to the improvement of grinding technology for the pure components did not lead to the desired result. Despite optimized technology, the grinding yields were higher with the inventive wax combinations than with the pure products.

| Com- | | Example 1 | Example 2 | Example 3 |
|---|---|---|---|---|
| ponent | Compound | (comparison) | (inventive) | (inventive) |
| A | Glycerol monotanate | 85 | 85 | 85 |
| A | Montane wax acid | 15 | 15 | 15 |
| B | Amide wax C | — | 10 | — |
| C | PE wax PE 130 | — | — | 10 |
| | Mixture | 100 | 110 | 110 |
| | Grinding | 350 | 800 | 500 |
| | performance g/h | | | |

### EXAMPLE MIXTURE 2

| | | Example 4 | Example 5 | Example 6 |
|---|---|---|---|---|
| Component | Compound | (comparison) | (inventive) | (inventive) |
| A | Pentaerythritol | 85 | 85 | 85 |
| | monotanate | | | |
| A | Montane wax acid | 15 | 15 | 15 |
| B | Amide wax C | — | 15 | — |
| C | PE wax PE 130 | — | — | 15 |
| | Mixture | 100 | 115 | 115 |
| | Grinding | 350 | 500 | 450 |
| | performance g/h | | | |

### EXAMPLE MIXTURE 3

| Component | Compound | Example 8 | Example 9 | Example 10 |
|---|---|---|---|---|
| A | Ethanediol | 10 | 10 | 10 |
| | monomontanate | | | |
| A | Ethanediol | 20 | 20 | 20 |
| | dimontanate | | | |
| A | Butanediol | 20 | 20 | 20 |
| | 1,3-montanate | | | |
| | Ca montanate | 45 | 45 | 45 |
| A | Montane wax acid | 5 | 5 | 5 |
| B | Amide wax C | — | 10 | — |
| C | PE wax PE 130 | — | — | 15 |
| | Mixture | 100 | 115 | 115 |
| | Grinding | 350 | 500 | 450 |
| | performance g/h | | | |
| Component | Compound | Example 11 | Example 12 | Example 13 |
| A | Sorbitol monotanate | 85 | 85 | 85 |
| A | Montane wax acid | 15 | 15 | 15 |
| B | Amide wax C | — | 20 | — |
| C | PE wax PE 130 | — | — | 35 |
| | Mixture | 100 | 120 | 135 |
| | Grinding | 450 | 650 | 600 |
| | performance g/h | | | |

| | | Example 14 | Example 15 |
|---|---|---|---|
| Component | Compound | (comparison) | (inventive) |
| A | Sorbitol montanate/stearate | 100 | 85 |
| B | Amide wax HS | — | 15 |
| | Mixture | 100 | 100 |
| | Grinding performance g/h | 500 | 800 |
| | | Example 16 | Example 17 |
| Component | Compound | (comparison) | (inventive) |
| A | Carnauba wax | 100 | 85 |
| C | PE wax H2 | — | 15 |
| | Mixture | 100 | 100 |
| | Grinding performance g/h | 350 | 550 |
| | | Example 18 | Example 19 |
| Component | Compound | (comparison) | (inventive) |
| A | Modified olefin copolymer | 100 | 85 |
| B | Amide wax | — | 15 |
| | Mixture | 100 | 100 |
| | Grinding performance g/h | 1000 | 1600 |
| | | Example 20 | Example 21 |
| Component | Compound | (comparison) | (inventive) |
| A | Olefin copolymer CE 1 | 100 | 85 |
| C | PE wax | — | 15 |
| | Mixture | 100 | 100 |
| | Grinding performance g/h | 400 | 650 |
| | | Example 22 | Example 23 |
| Component | Compound | (comparison) | inventive |
| A | Montane wax acid | 0 | 5 |
| D | PE wax oxidate | 100 | 95 |
| | Mixture | 100 | 100 |
| | Grinding performance g/h | 400 | 650 |

The grinding process used an AFG 100 countercurrent fluidized-bed mill, Hosokawa Alpine. The target size for the particles was D50 of 10-12 μm.

The examples lists show that the inventive mixtures of finely ground waxes give a considerable improvement during the grinding process.

### APPLICATION EXAMPLES

Pigment Dispersion in Powder Coating:

It is known that the dispersion of the pigments can be improved via the use of montane waxes. In order to achieve a high level of activity it is necessary that the products are used in the form of powders or micropowders. It has now been found that use of the inventive mixtures can achieve not only improved pigment dispersion but also an increase in extrusion output. At the same time, the costs for the production of the inventive wax combination were markedly lower when comparison is made with a pure montane wax, and therefore operations with the inventive wax mixtures can be substantially more cost-effective.

Examples of formulations for powder coating (all data in parts by weight)

Power Coating A:

| | | |
|---|---|---|
| 70.0 | parts of | binder |
| 9.0 | parts of | Blanc Fixe N |
| 20.0 | parts of | ® Kronos 2310 titanium dioxide |
| 1.0 | part of | ® Hostaperm Blue A4R |
| 0.5/1.0/2.0 | part(s) of | montanic acid derivative (® Ceridust 5551, |
| | | Clariant GmbH) |

Power Coating B:

| | | |
|---|---|---|
| 70.0 | parts of | binder |
| 9.0 | parts of | Blanc Fixe N |
| 20.0 | parts of | ® Kronos 2310 titanium dioxide |
| 1.0 | part of | ® Red Violet ER 02 |
| 0.5/1.0/2.0 | part(s) of | montanic acid derivative (® Ceridust 5551, |
| | | Clariant GmbH) |

Power Coating C:

| | | |
|---|---|---|
| 70.0 | parts of | binder |
| 9.0 | parts of | Blanc Fixe N |
| 20.0 | parts of | ® Kronos 2310 titanium dioxide |
| 1.0 | part of | ® Hostaperm Blue A4R |
| 1.0 | part of | waxes of example 4/example 2/example 3 |

Power Coating D:

| | | |
|---|---|---|
| 70.0 | parts of | binder |
| 9.0 | parts of | Blanc Fixe N |
| 20.0 | parts of | ® Kronos 2310 titanium dioxide |
| 1.0 | part of | ® Red Violet ER 02 |
| 1.0 | part of | waxes of example 4/example 2/example 3 |

were produced by way of the following steps in a process
premixing all the components in a Mixaco mixer
extrusion in a twin-screw APV Baker laboratory extruder at 110° C.
comminuting in a Retsch pinned disc mill
sieving to a grain fineness smaller than 125 μm

The composition of the binder is:

| | |
|---|---|
| 90.13% | ® Alftalat AN 989 (Vianova Resins) |
| 4.74% | ® Primid XL 552 (EMS Chemie) |
| 4.37% | ® Additol XL 9824 (Vianova Resins) |
| 0.29% | ® Benzoin |
| 0.47% | ® Hostanox M 101 (Clariant GmbH) |

The average particle size after extrusion was 9 μm.

The powder was applied by means of an electrostatic spraying device from Wagner to metal substrates and stoved for 10 minutes at 180° C. The color strength of the coating is measured to DIN 55986 in a CM 3600d spectrophotometer from Minolta. To calculate the relative color strength, the measured value is based on the value measured for the control specimen (without dispersing agent; control specimen=100%). Values greater than 100 mean higher color strength than the control specimen, and values smaller than 100 mean lower color strength.

| | Hostaperm Red Violet | |
|---|---|---|
| | ER 02 | Hostaperm Blue A4R |
| Inventive wax | Rel. color strength % | Rel. color strength % |
| Parts by weight | | |
| 0 | 100 | 100 |
| 0.5 | 108 | 114 |
| 1.0 | 120 | 123 |
| 2.0 | 127 | 132 |
| 1.0 part by weight | | |
| None | 100 | 100 |
| Ceridust 5551 | 120 | 123 |
| Example 4 | 119 | 125 |
| Example 2 | 123 | 120 |
| Example 3 | 121 | 122 |

It could be shown that the addition of an inventive mixture as dispersing agent improves the dispersion of pigments and therefore increases the color strength.

1. A mixture of finely ground waxes comprising two or more components selected from the group consisting of A, B, C, and D, wherein component A is an ester wax, component B is an amide wax, component C is a hydrocarbon wax, and component D is an oxidized long-chain hydrocarbon wax.

2. The mixture of finely ground waxes as claimed in claim 1, wherein the ester wax is selected from the group consisting of a natural ester wax and a synthetic ester wax.

3. The mixture of finely ground waxes as claimed in claim 2, wherein the natural ester wax is selected from the group consisting of montane waxes, carnauba wax, candelilla wax, sugarcane wax and mixtures thereof.

4. The mixture of finely ground waxes as claimed in claim 1, wherein the montane wax is selected from the group consisting of montane wax acid, derivatives of montane wax acid and mixtures thereof.

5. The mixture of finely ground waxes as claimed in claim 2, wherein the synthetic ester wax is selected from the group consisting of sorbitan esters of saturated fatty acids, esters of polyols, and mixtures thereof.

6. The mixture of finely ground waxes as claimed in claim 2, wherein the synthetic ester wax is a copolymer composed of long-chain olefins having from 5 to 18 carbon atoms and of unsaturated acids.

7. (canceled)

8. The mixture of finely ground waxes as claimed in claim 6, wherein the copolymer is a copolymer whose carboxy functionality has been modified via reaction with long-chain alcohols, perfluoroalkyl alcohols, short-chain amines, or long-chain amines.

9. The mixture of finely ground waxes as claimed in claim 8, wherein the long-chain alcohols are tallow fatty alcohol, coconut fatty alcohol, or oxo alcohols.

10. The mixture of finely ground waxes as claimed in claim 8, wherein the perfluoroalkyl alcohols are C₈-C₁₈-perfluoroalkylpropanol or narrower cuts thereof.

11. The mixture of finely ground waxes as claimed in claim 8, wherein the short-chain amines are butylamine, dimethylaminopropylamine, diethylaminoethanol, tetramethylpiperidinol, or diacetonediamine.

12. The mixture of finely ground waxes as claimed in claim 8, wherein the long-chain amines are tallow fatty amine, octylamine, palmitylamine, or stearylamine.

13. The mixture of finely ground waxes as claimed in claim 1, wherein the amide wax is the reaction product of an amine component and of long-chain fatty acids or hydroxy fatty acids, or mixtures thereof.

14. The mixture of finely ground waxes as claimed in claim 13, wherein the amine component is ethylenediamine, or hexamethylenediamine.

15. The mixture of finely ground waxes as claimed in claim 1, wherein the amide wax is the reaction product of ammonia and of long-chain fatty acids, hydroxy fatty acids, or mixtures thereof.

16. The mixture of finely ground waxes as claimed in claim 1, wherein the amide wax is the reaction product of long-chain amines and of long-chain fatty acids hydroxy fatty acids, or mixtures thereof.

17. The mixture of finely ground waxes as claimed in claim 1, wherein the hydrocarbon wax is a polyethylene wax.

18. The mixture of finely ground waxes as claimed in claim 17, wherein the polyethylene wax is a polyethylene wax prepared by the Ziegler process or by metallocene technology.

19. The mixture of finely ground waxes as claimed claim 1, wherein the polyethylene wax is a Fischer-Tropsch waxes wax.

20. The mixture of finely ground waxes as claimed in claim 1, further comprising
from 5 to 99% by weight of component A
from 0 to 95% by weight of component B
from 0 to 95% by weight of component C, and
from 0 to 95% by weight of component D,
where the entirety of the components is 100% by weight.

21. The mixture of finely ground waxes as claimed in claim 1, further comprising
from 40 to 90% by weight of component A
from 0 to 60% by weight of component B
from 0 to 60% by weight of component C and
from 0 to 60% by weight of component D,
where the entirety of the components is 100% by weight.

22. The A printing ink or coating comprising a mixture of finely ground waxes as claimed in claim 1.

23. A plastic comprising a mixture of finely ground waxes as claimed in claim 1.

24. A crop-protection preparation comprising a mixture of finely around waxes as claimed in claim 1.

25. A lubricant for plastics comprising a mixture of finely ground waxes as claimed in claim 1.

26. The mixture of finely ground waxes as claimed in claim 4, wherein the derivatives of montane wax acid are selected from the group consisting of esters of montane wax acid, soaps of montane wax acid, esteramides of montane wax acid, a mixture of derivatives of montane wax acid with long-chain fatty acids and mixtures thereof.

27. The mixture of finely ground waxes as claimed in claim 5, wherein the esters of polyols are selected from the group consisting of pentaerythritol, glycerol, trimethylolpropane, with long-chain fatty acids and/or their mixtures.

28. The mixture of finely ground waxes as claimed in claim 6, wherein the copolymer is selected from the group consisting of acrylic acid, methacrylic acid, maleic anhydride, itaconic acid, and derivatives thereof.

29. The mixture of finely ground waxes as claimed in claim 28, wherein the derivatives are methyl, ethyl, butyl, and/or 2-ethyhexyl esters of acrylic acid, methacrylic acid, maleic anhydride, or itaconic acid.

30. The mixture of finely ground waxes as claimed in claim 16, wherein the long chain amines are selected from the group consisting of hydrogenated tallow fatty amine, stearylamine, palmitylamine, and coconut fatty amine.

31. A pigment dispersant comprising a mixture of finely ground waxes as claimed in claim 1.

32. A powder coating comprising a mixture of finely ground waxes as claimed in claim 1.
